(19) United States
(12) Patent Application Publication
(10) Pub. No.: US 2007/0073938 A1
(43) Pub. Date: Mar. 29, 2007

(54) Semiconductor for performing direct memory access without FIFO and method for processing data thereof

(75) Inventor: Ki-Yeol Kim, Gunpo-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/492,469

(22) Filed: Jul. 25, 2006

(30) Foreign Application Priority Data
Sep. 28, 2005 (KR) 10-2005-0090787

(51) Int. Cl. G06F 13/38

(52) U.S. Cl. 710/62

(57) ABSTRACT

A semiconductor for performing DMA without using a FIFO unit includes a memory for storing data, a CPU for processing data, a universal asynchronous receiver/transmitter (UART) and a control circuit block. The control circuit block controls storage of receive data, which is output from the UART, in the memory based on an upper address output from the CPU and a lower address output from the UART in the DMA mode and controls storage of transmit data, which is transmitted by the CPU, in the memory in response to a transfer address generated by the CPU in the CPU access mode. The UART in the DMA mode extracts receive data from a received receive frame and outputs the receive data to the control circuit block, or receives the transmit data read from the memory based on the upper address and the lower address, generates a transmit frame including the transmit data and outputs the transmit frame. In the DMA mode, a clock signal supplied to the CPU is intercepted.

### CROSS-REFERENCE TO RELATED PATENT APPLICATION

This application claims the benefit of Korean Patent Application No. 10-2005-0090787 filed on Sep. 28, 2005, in the Korean Intellectual Property Office, the disclosure of which is incorporated herein in its entirety by reference.

### BACKGROUND OF THE INVENTION

1. Technical Field

The present disclosure relates to an apparatus and a method for processing data, and more particularly, to an integrated circuit capable of performing DMA (direct memory access) without using a FIFO (first in first out) operation while consuming reduced power, an integrated circuit card comprising the integrated circuit and a method for processing data of the integrated circuit card.

2. Discussion of the Related Art

An integrated circuit card, also called a ‘smart card’, receives data and power from a terminal using an RF (radio frequency) signal.

FIG. 1 is a block diagram of an integrated circuit used in an integrated circuit card to perform DMA using FIFO. Referring to FIG. 1, the integrated circuit 10 comprises a universal asynchronous receiver/transmitter (UART) 20, a FIFO unit 24, a CPU 26 and a memory 28.

When data is received, the input data RX is written in a buffer 22 of the UART 20, the data read from the buffer 22 is input to the FIFO unit 24 under control of the UART 20 and the data output from the FIFO unit 24 is stored in the memory 28 under control of the CPU 26.

When data is transmitted, the data output from the memory 28 is stored in the FIFO unit 24 under control of the CPU 26, the data output from the FIFO unit 24 is input to the buffer 22 of the UART 20 under control of the UART 20 and the data stored in the buffer 22 is output as output data TX.

The integrated circuit 10, as shown in FIG. 1, comprises the FIFO unit 24 in addition to the memory 28 which the CPU 26 can access. Therefore, the layout area of the integrated circuit 10 is increased and program codes installed in the CPU 26 necessary to access the FIFO unit 24 are increased. Further, the current needed to drive the FIFO unit 24 is increased.

Also, an integrated circuit card with an integrated circuit installed thereon operates using RF power supplied from a terminal. When the distance between the integrated circuit card and the terminal, referred to as an ‘operational distance’, is increased, the RF power which is supplied to the integrated circuit card is decreased. If the integrated circuit card efficiently uses the supplied RF power, the consumed amount of the RF power can be reduced even though the operational distance is increased and, consequently, the operation of the integrated circuit card is stably secured. Therefore, it is possible to increase the operational distance and still utilize the smart card.

In order to efficiently use the RF power, the integrated circuit card has a power save mode. The power save mode includes a stop mode, an idle mode, etc. The stop mode and the idle mode are described below with reference to FIG. 2 and FIG. 3, respectively.

FIG. 2 is a diagram for understanding the method of controlling a clock signal in the stop mode of the integrated circuit shown in FIG. 1. Referring to FIG. 2, a clock control block 30 intercepts and blocks (OFF) a clock signal CLK to be supplied to a memory clock path 25, the CPU 26, a co-processor 27 and a peripheral circuit clock path 29 in response to the stop mode signal CTRL_SM output from the CPU 26 to the clock control block 30.

Therefore, the clock signal CLK to be supplied to a RAM 31, an EEPROM 32, a ROM 33, a WDT (watchdog timer) 34, a TIMER 35 and the UART 22 is also off. Thus, the integrated circuit card comprising the integrated circuit 10 consumes little of the supplied power.

When a wake-up signal WKU is input to the clock control block 30, the clock control block 30 supplies a clock signal CLK to the memory clock path 25, the CPU 26, the co-processor 27 and the peripheral circuit clock path 29 again. Therefore, the integrated circuit card comprising the integrated circuit 10 can perform a normal operation.

FIG. 3 is a diagram for understanding the method of controlling a clock signal in the idle mode of the integrated circuit shown in FIG. 1. Referring to FIG. 3, the clock control block 30 intercepts and blocks (OFF) a clock signal CLK to be supplied to the memory clock path 25, the CPU 26 and the co-processor 27 but maintains (ON) only the clock signal CLK supplied to the peripheral circuit clock path 29 in response to an idle mode signal CTRL_IM output from the CPU 26 to the clock control block 30.

Therefore, the clock signal CLK to be supplied to the RAM 31, the EEPROM 32 and the ROM 33 is intercepted and blocked (OFF) and only the WDT (watchdog timer) 34, the TIMER 35 and the UART 22, which have been activated before entering the idle mode, operate. Thus, the power consumed by the integrated circuit card comprising the integrated circuit 10 is considerably reduced. When a wake-up signal WKU is input to the clock control block 30, the clock control block 30 supplies the clock signal CLK to the memory clock path 25, the CPU 26, the co-processor 27 and the peripheral circuit clock path 29 once again. Therefore, the integrated circuit card comprising the integrated circuit 10 performs a normal operation.

Generally, an integrated circuit card comprising an integrated circuit receives data and power from a terminal using an RF signal. Meanwhile, in the data communication section, there may exist a part where power is not stable according to a communication protocol, so that normal communication cannot be performed.

### SUMMARY OF THE INVENTION

Exemplary embodiments of the present invention provide an integrated circuit having a DMA structure that consumes low power, an integrated circuit card comprising the integrated circuit, and a method for processing data of the integrated circuit card.

In order to accomplish the above, the semiconductor according to an embodiment of the present invention comprises a memory for storing data, a CPU for processing data, a universal asynchronous receiver/transmitter (UART) and a control circuit block

The control circuit block controls storage of receive data, which is output from the UART, in the memory based on an upper address output from the CPU and a lower address output from the UART in the DMA mode or controls storage of transmit data, which is transmitted by the CPU, in the memory in response to a transfer address generated by the CPU, in the CPU access mode.

The UART in the DMA mode receives a receive frame, extracts receive data from the receive frame and outputs the extracted receive data to the control circuit block, or receives the transmit data read from the memory based on the upper address and the lower address, creates a transmit frame including the transmit data and outputs the created transmit frame. In the DMA mode, a clock signal supplied to the CPU is intercepted.

The control circuit block comprises a first selection circuit, an address generating circuit and a second selection circuit. The first selection circuit outputs any one of the receive data output from the UART and the transmit data to be transmitted by the CPU to the memory in response to an enable signal output from the CPU. The address generating circuit stores the upper address output from the CPU and the lower address output from the UART.

The second selection circuit outputs any one of an address output from the address generating circuit and a transfer address to the memory in response to an enable signal output from the CPU. The memory stores the receive data or outputs the transmit data to the UART in response to the address output from the address generating circuit, and transfers the receive data to the CPU in response to a receive address created by the CPU.

According to an embodiment of the present invention, the method for processing data of a semiconductor comprises: (a) converting received series data into parallel data by a UART so that a CPU can process the data and outputting the parallel data; (b) storing the parallel data output from the UART in a memory, based on a upper address output from the CPU and a lower address output from the UART; and (c) reading the parallel data stored in the memory by the CPU using a receive address. The method may further comprise a step for intercepting a clock signal supplied to the CPU when the step (a) and the step (b) are performed.

According to an embodiment of the present invention, the method for processing data of a semiconductor comprises: (a) storing parallel data to be transferred by a CPU in a memory using a transfer address; and (b) receiving the parallel data read from the memory, converting the parallel data into series data for transmission and outputting the series data, based on an upper address output from the CPU and a lower address output from a UART. The method may further comprise a step for intercepting a clock signal supplied to the CPU when the step (b) is performed.

### BRIEF DESCRIPTION OF THE DRAWINGS

Exemplary embodiments of the present invention can be understood in more detail from the following descriptions taken in conjunction with the attached drawings in which:

FIG. 1 is a block diagram of an integrated circuit used in an integrated circuit card to perform DMA using a FIFO unit;

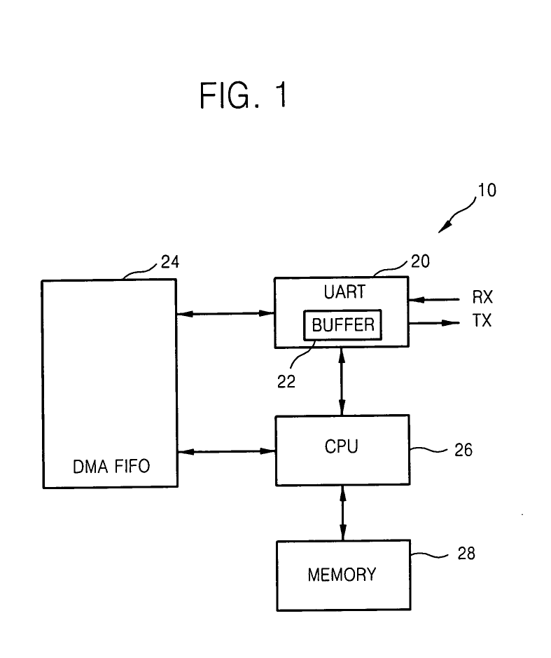

FIG. 2 is a diagram for explaining the method of controlling a clock signal in the stop mode of the integrated circuit shown in FIG. 1;

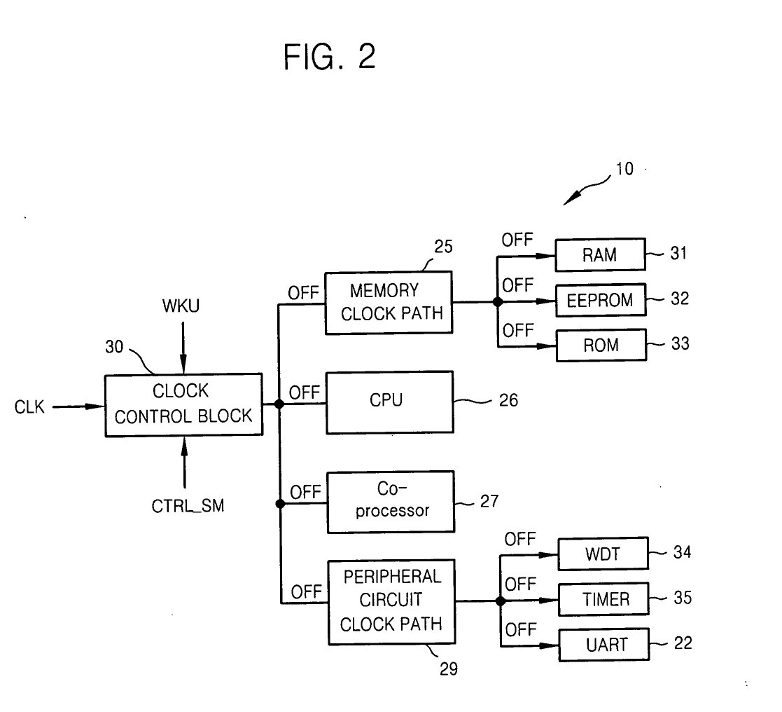

FIG. 3 is a diagram for explaining the method of controlling a clock signal in the idle mode of the integrated circuit shown in FIG. 1;

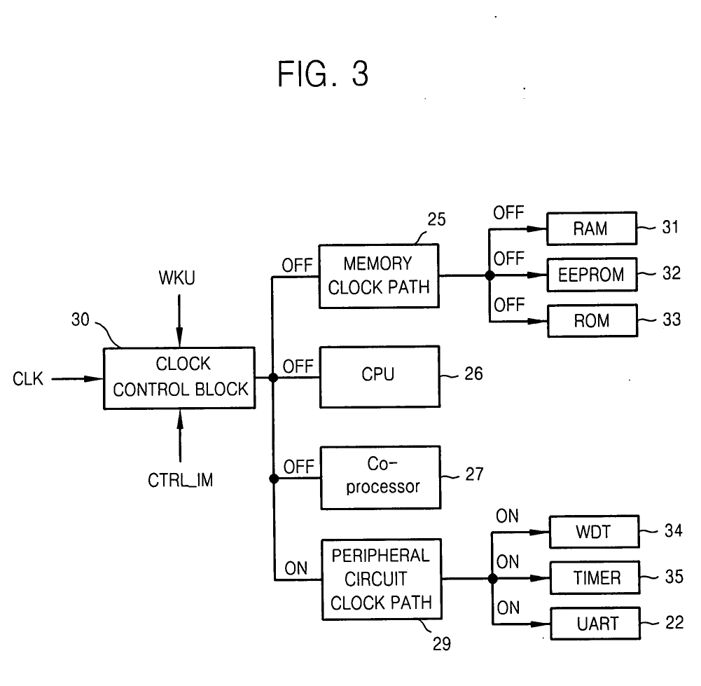

FIG. 4 is a block diagram of a semiconductor for performing DMA using a memory according to an embodiment of the present invention; and

FIG. 5 is a diagram for explaining the method of controlling a clock signal in the stop mode of the semiconductor shown in FIG. 4.

### DETAILED DESCRIPTION OF EXEMPLARY EMBODIMENTS

The attached drawings illustrating exemplary embodiments of the present invention are referred to in order to gain a sufficient understanding of the present invention, the merits thereof, and the objectives accomplished by the embodiments of the present invention.

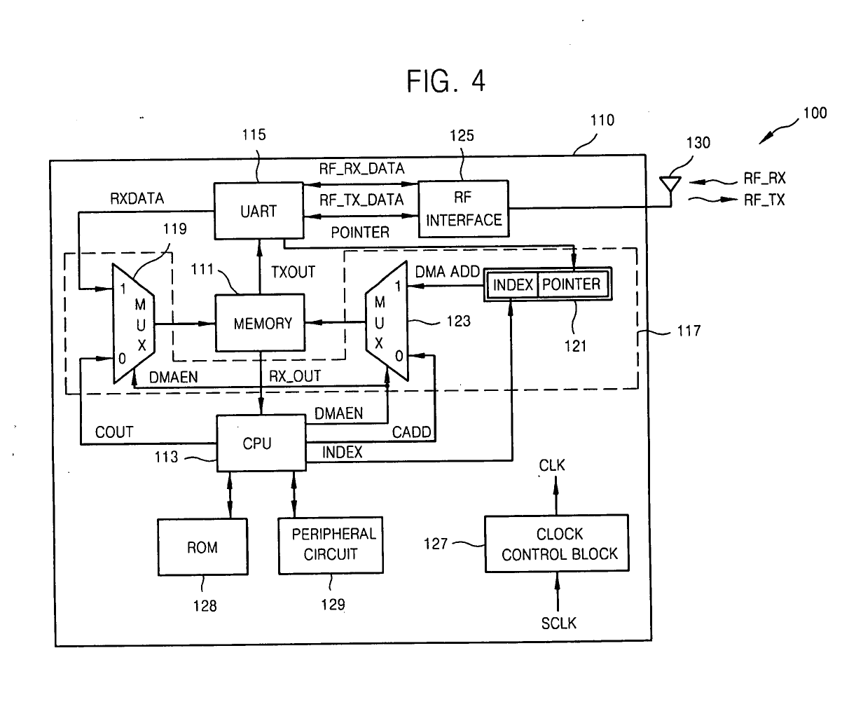

FIG. 4 is a block diagram of a semiconductor for performing DMA using a memory according to an embodiment of the present invention. Referring to FIG. 4, the semiconductor 100 according to an embodiment of the present invention comprises an integrated circuit 110 and an antenna 130. The semiconductor 100 may be an IC card, a smart card or a contact-less IC (integrated circuit) card.

The integrated circuit 110 comprises a memory 111 for storing given data, a CPU 113 for controlling the general operation of the integrated circuit 110 or the integrated circuit card 100, a universal asynchronous receiver/transmitter (UART) 115, a control circuit block 117, a ROM 128, a peripheral circuit 129, and a clock control block 127. The memory 111 may be implemented as a volatile memory such as RAM or as a non-volatile memory such as EEPROM or a flash memory.

The control circuit block 117 controls storage of receive data RXDATA, which is output from the UART 115, in the memory 111 based on an upper address INDEX output from the CPU 113 and a lower address POINTER output from the UART 115, or storage of transmit data COUT, which is transmitted by the CPU 113, in the memory 111, in response to a transfer address CADD generated by the CPU 113.

The UART 115 receives a receive frame RF_RX_DATA, extracts the receive data RXDATA from the receive frame RF_RX_DATA and outputs the extracted receive data RXDATA to a first selection circuit 119 of the control circuit block 117. Also, the UART 115 receives a transmit data TXOUT read from the memory 111, generates a transmit frame RF_TX_DATA including the transmit data TXOUT and outputs the generated transmit frame RF_TX_DATA, based on the upper address INDEX and the lower address POINTER.

An RF interface 125 transmits the receive frame RF_RX_DATA, corresponding to a RF receive signal RF_RX received through the antenna 130, to the UART 115. Also, the RF interface 125 generates an RF transmit signal RF_TX and transmits it to the outside through the antenna 130 in response to the transmit frame RF_TX_DATA output from the UART 115. The control circuit block 117 comprises the first selection circuit 119, an address generating circuit 121, and a second selection circuit 123.

The first selection circuit 119 outputs any one of the receive data RXDATA output from the UART 115 and the transmit data COUT to be transmitted by the CPU 113 to the memory 111 in response to an enable signal DMAEN output from the CPU 113.

The address generating circuit 121 stores the upper address INDEX output from the CPU 113 and the lower address POINTER output from the UART 115. The address generating circuit 121 may be implemented as a register block comprising a plurality of registers, but is not limited thereto.

The second selection circuit 123 outputs any one of an address DMA_ADD output from the address generating circuit 121 and a transfer address CADD output from the CPU 113 to the memory 111 in response to the enable signal DMAEN output from the CPU 113. The memory 111 stores the receive data RXDATA output from the first selection circuit 119 or outputs the stored transmit data COUT=TXOUT to the UART 115 in response to the address DMA_ADD output from the address generating circuit 121. The memory 111 transfers the receive data RXDATA=RX_OUT to the CPU 113 in response to a receive address CADD generated by the CPU 113.

The clock control block 127 generates a clock signal CLK to be supplied to at least one of the memory 111, the CPU 113, the universal asynchronous receiver/transmitter 115 and the control circuit block 117 from a source clock signal SCLK. The clock control block 127 may be implemented (or, embedded) in the RF interface 125.

Now, the operation of the universal asynchronous receiver/transmitter 115 accessing the memory 111, referred to as the ‘DMA mode’, and the operation of the CPU 113 accessing the memory 111, referred to as the ‘CPU access mode’, are described in detail with reference to FIG. 4. The integrated circuit card 100 communicates with a terminal (not shown) in the DMA mode.

Upon receiving data, the RF interface 125 converts an RF receive signal RF_RX input through the antenna 130 into the receive frame RF_RX_DATA and transfers it to the UART 115. The UART 115 receives the receive frame RF_RX_DATA, extracts the receive data RXDATA from the received receive frame RF_RX_DATA and outputs the extracted receive data RXDATA to the control circuit block 117.

The CPU 113 activates the DMA enable signal DMAEN. Therefore, the first selection circuit 119 outputs the receive data RXDATA from the UART 115 to the memory 111 in response to the activated DMA enable signal DMAEN and the second selection circuit 123 outputs the address DMA_ADD output from the address generating circuit 121 to the memory 111 in response to the activated DMA enable signal DMAEN. The address DMA_ADD from the address generating circuit 121 is an address generated by combining the upper address INDEX output from the CPU 113 and the lower address POINTER output from the UART 115.

The upper address INDEX, which is an address set by the CPU 113 before the integrated circuit card 100 enters the DMA mode, assigns the size of the reception region, for example, 256 bytes, in the memory 111 to store the receive data RXDATA. The CPU 113 regulates the number of bits constituting the upper address INDEX to determine a starting location of the reception region. The lower address POINTER constitutes the address in the reception region. The memory 111 stores the receive data RXDATA in a region assigned by the address DMA_ADD.

When the CPU 113 accesses the receive data RXDATA, that is, in the CPU access mode, the CPU 113 inactivates the DMA enable signal DMAEN. Therefore, the second selection circuit 123 outputs the address CADD output from the CPU 113 to the memory 111 in response to the inactivated DMA enable signal DMAEN. The memory 111 outputs the receive data RXDATA=RX_OUT to the CPU 113 in response to the address CADD. The CPU 113 processes the receive data RX_OUT.

When the CPU 113 transmits data, the CPU 113 inactivates the DMA enable signal DMAEN. Therefore, the first selection circuit 119 outputs the transmit data COUT output from the CPU 113 to the memory 111 in response to the inactivated DMA enable signal DMAEN. The second selection circuit 123 outputs the address CADD output from the CPU 113 to the memory 111 in response to the inactivated DMA enable signal DMAEN. The memory 111 stores the transmit data COUT in a region assigned by the address CADD.

Upon completion of the storage of the transmit data COUT, the CPU 113 activates the DMA enable signal DMAEN. The UART 115 outputs the lower address POINTER to the address generating circuit 121 to transmit the transmit data COUT. The second selection circuit 123 outputs the address DMA_ADD output from the address generating circuit 121 to the memory 111 in response to the activated DMA enable signal DMAEN. The address DMA_ADD is formed by combining the upper address INDEX and lower address POINTER, in which the upper address assigns an upper address of the region where data is stored and the lower address assigns a lower address of the same region.

The memory 111 outputs the transmit data COUT=TXOUT stored in the region assigned by the address DMA_ADD to the UART 115. Thus, the UART 115 reads the transmit data COUT=TXOUT. The UART 115 creates a transmit firame including the transmit data TXOUT and outputs the created transmit frame RF_TX_DATA to the RF interface 125. For example, the UART 115 converts parallel data into series data, but is not limited thereto.

The RF interface 125 converts the transmit frame RF_TX_DATA into an RF transmit signal and transfers it to a terminal (not shown) through the antenna 130.

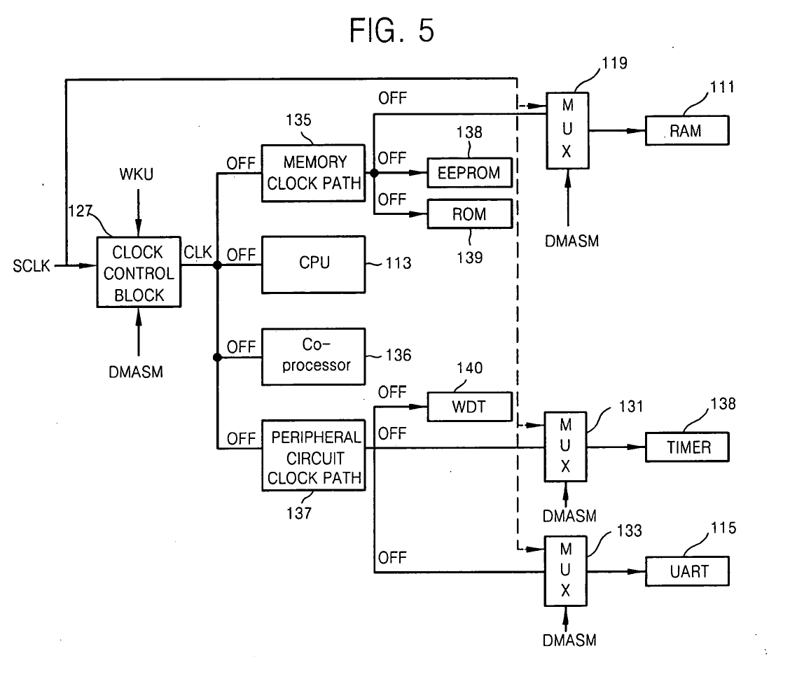

FIG. 5 is a diagram for explaining the method of controlling a clock signal in the stop mode of the semiconductor shown in FIG. 4. Referring to FIG. 4 and FIG. 5, when the semiconductor, for example, an integrated circuit card, 100 performs the DMA mode, the clock control block 127, which generates a clock signal CLK in response to a source clock signal SCLK, intercepts and blocks (OFF) the clock signal CLK to be supplied to a memory clock path 135, the CPU 113, a co-processor 136 and a peripheral circuit clock path 137 in response to a DMA mode signal DMASM output from the CPU 113. The source clock signal SCLK and the clock signal CLK are preferably identical with each other.

However, selection circuits MUX 119, MUX 131 and MUX 133 supply the source clock signal SCLK only to an apparatus needed for transmission and reception of data, including, for example, a RAM 111, a timer 138 and a universal asynchronous receiver/transmitier 115 in response to the DMA mode signal DMASM fed to the clock control block 127. The source clock signal SCLK is not fed to other elements, such as an EEPROM 138, a ROM 139, or a WDT 140. Thus, the power used in the integrated circuit card 100 is reduced.

The integrated circuit card 100 according to an embodiment of the present invention can smoothly transmit and receive data regardless of unstable power, since the current consumed by the integrated circuit card 100 is minimized even in the zone where the power of the integrated circuit card 100 is unstable due to the transmission and reception of data.

As described above, in the semiconductor according to an embodiment of the present invention, a universal asynchronous receiver/transmitter can perform DMA using a memory without a separate FIFO unit and the layout area of the semiconductor is thus reduced.

Also, in the semiconductor according to an embodiment of the present invention, by intercepting an operation unnecessary in transmitting and receiving the data, particularly the supply of a clock signal to a CPU, it is possible to reduce the current consumed in the semiconductor. Therefore, the power is stabilized and the data transmission and reception rate of the semiconductor is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A semiconductor comprising:
a memory for storing data;
a central processing unit (CPU);
a universal asynchronous receiver/transmitter (UART); and
a control circuit block for controlling storage of receive data, which is output from the UART, in the memory based on an upper address output from the CPU and a lower address output from the UART and for controlling storage of transmit data, which is transmitted by the CPU, in the memory in response to a transmit address generated by the CPU,
wherein the UART receives a receive frame transmitted to the semiconductor, extracts a receive data from the receive frame and outputs the extracted receive data to the control circuit block, and the UART receives the transmit data read from the memory based on the upper address and the lower address, generates a transmit frame including the transmit data and outputs the generated transmit frame.

2. The semiconductor of claim 1, further comprising an RF interface for generating the receive frame in response to an RF receive signal and for generating an RF transmit signal in response to the transmit frame.

3. The semiconductor of claim 2, further comprising an antenna for receiving the RF receive signal and for transmitting the RF transmit signal.

4. The semiconductor of claim 3, wherein the semiconductor comprises a contact-less IC card.

5. The semiconductor of claim 1, wherein the control circuit block comprises:
a first selection circuit for outputting any one of the receive data output from the UART and the transmit data to be transmitted by the CPU to the memory in response to an enable signal output from the CPU;
an address generating circuit for storing the upper address output from the CPU and the lower address output from the UART; and
a second selection circuit for outputting any one of an address output from the address generating circuit and the transmit address generated by the CPU to the memory in response to the enable signal output from the CPU,
wherein the memory stores the receive data or outputs the transmit data to the UART in response to the address output from the address generating circuit, and transmits the receive data to the CPU in response to a receive address generated by the CPU.

6. The semiconductor of claim 2, wherein the control circuit block comprises:
a first selection circuit for outputting the receive data output from the UART to the memory in response to an activated enable signal output from the CPU and outputting the transmit data to be transferred by the CPU to the memory in response to an inactivated enable signal;
an address generating circuit for storing the upper address output from the CPU and the lower address output from the UART; and
a second selection circuit for outputting an address output from the address generating circuit to the memory in response to the activated enable signal and outputting the transmit address to the memory in response to the inactivated enable signal,
wherein the memory stores the receive data or outputs the transmit data to the UART in response to the address output from the address generating circuit and transmits the receive data to the CPU in response to a receive address generated by the CPU.

7. The semiconductor of claim 1, further comprising a clock control block for generating a clock signal to be supplied to at least one of the memory, the CPU, the UART and the control circuit block, wherein the clock control block intercepts the clock signal supplied to the CPU when the receive data output from the UART is stored in the memory or when the UART receives the transmit data read from the memory, in response to a control signal output from the CPU.

8. A method for processing data in a semiconductor comprising:
(a) converting received series data into parallel data by a universal asynchronous receiver/transmitter (UART) so that a central processing unit (CPU) can process the data and outputting the parallel data;
(b) storing the parallel data output from the UART in a memory, based on a upper address output from the CPU and a lower address output from the UART; and
(c) reading the parallel data stored in the memory by the CPU using a receive address generated by the CPU.

9. The method of claim 8, further comprising the step of intercepting a clock signal supplied to the CPU when the step (a) and the step (b) are performed.

10. A method for processing data in a semiconductor comprising:
(a) storing parallel data to be transferred by a central processing unit (CPU) in a memory using a transfer address; and
(b) receiving the parallel data read from the memory based on an upper address output from the CPU and a lower address output from a universal asynchronous receiver/transmitter, converting the parallel data into series data so as to transmit the parallel data and outputting the series data.

11. The method of claim 11, further comprising the step of intercepting a clock signal supplied to the CPU when the step (b) is performed.

12. A semiconductor comprising a memory for storing data, a central processing unit (CPU) for processing the data and a universal asynchronous receiver/transmitter (UART), in which
the memory and the UART exchange predetermined data in a DMA mode, based on an upper address output from the CPU and a lower address output from the UART, and
the memory and the CPU exchange predetermined data in a CPU access mode, based on an address generated by the CPU.

13. The semiconductor of claim 12, further comprising a control circuit block for controlling storage of receive data, which is output from the UART, in the memory based on the upper address output from the CPU and the lower address output from the UART, and for controlling storage of transmit data, which is transmitted by the CPU, in the memory in response to a transmit address generated by the CPU,
wherein the UART converts a receive frame into the receive data and outputs the receive data to the control circuit block, or converts the transmit data read from the memory based on the upper address and the lower address into a transmit frame including the transmit data and outputs the transmit frame.
